(19) United States
(12) Patent Application Publication
(10) Pub. No.: US 2014/0311417 A1
(43) Pub. Date: Oct. 23, 2014

(54) Method for Regulating Energy Consumption in Aquaculture Systems

(71) Applicants: Robert W. Stiles, JR., Cary, NC (US); Dennis P. DeLong, Raleigh, NC (US); Thomas Losordo, Raleigh, NC (US)

(72) Inventors: Robert W. Stiles, JR., Cary, NC (US); Dennis P. DeLong, Raleigh, NC (US); Thomas Losordo, Raleigh, NC (US)

(21) Appl. No.: 14/216,497

(22) Filed: Mar. 17, 2014

Related U.S. Application Data
(60) Provisional application No. 61/798,661, filed on Mar. 15, 2013.

(51) Int. Cl. A01K 63/04; A01K 63/00

(52) U.S. Cl. CPC A01K 63/042; A01K 63/006
USPC 119/263

(57) ABSTRACT

Some embodiments provide a recirculating aquaculture system for aquatic life. The system includes a culture tank, a plurality of sensors configured to control parameters in the system, a variable speed pump configured to circulate water through the culture tank, and a controller in communication with the plurality of sensors and the variable speed pump. The controller is configured to prioritize the plurality of control parameters based on a hierarchy list, select a highest priority control parameter, determine potential actions for each of the plurality of control parameters, and select a highest priority action based on at least one of the hierarchy list, the highest priority control parameter, a current power consumption of the variable speed pump, time of day, feeding cycle of the aquatic life, and resting cycles of the aquatic life. The controller is also configured to execute the highest priority action.

### CROSS REFERENCE TO RELATED APPLICATIONS

This application claims the benefit of U.S. Provisional Patent Application No. 61/798,661 filed on Mar. 15, 2013, the entire contents of which is incorporated herein by reference.

### BACKGROUND

Pumps may be used to recirculate water in aquatic farms, such as recirculating aquaculture systems in which fish and other aquatic life are raised. Recirculating aquaculture systems generally include one or more tanks (e.g., culture tank) to contain the fish, one or more water inlets into the tank(s), and one or more water outlets out of the tank(s). The water outlets are typically in communication with an inlet of a variable speed pump. The variable speed pump generally propels water through a filter and back into the tank through the water inlets.

Conventional recirculating aquaculture systems usually have a sizable upfront cost to design and build, and also have high operating costs that make it difficult for recirculating aquaculture farmers to compete with other types of aquaculture farms, such as ponds and net pen operations. Conventional recirculating aquaculture systems usually provide manually adjusted oxygen flow into a culture tank and manually adjusted water flow through the culture tank, depending upon the size or requirements of the aquatic life. As a result, typical recirculating aquaculture farms usually spend anywhere from about $50,000 to about $500,000 in electrical costs and about $12,000 to about $100,000 in oxygen costs on an annual basis. In fact, usually the highest operating costs for recirculating aquaculture farms are generally feed, electricity, and oxygen.

In conventional recirculating aquaculture systems, there are several parameters that are typically frequently monitored by the farmers in order to determine when feed rates for the fish may be increased. Presently, aquaculture farmers monitor ammonia and nitrogen output of the fish daily (by measuring the concentration of ammonia and nitrogen in the culture tank). In particular, the farmers monitor the amount of feed the fish may consume over a time period of about every 30 minutes to about 2 hours. In addition, the farmers monitor oxygen consumption of the fish and oxygen concentration of the water in the system constantly.

In light of the above obstacles, a need exists for a way in which to lower the production cost and operating cost of recirculating aquaculture systems.

### SUMMARY

Some embodiments provide a method of operating a pump in an aquaculture system that includes a culture tank that houses aquatic life. The method includes retrieving a plurality of control parameters, prioritizing the plurality of control parameters based on a hierarchy list, and selecting a highest priority control parameter. The method also includes determining potential actions for each of the plurality of control parameters, and selecting a highest priority action based on at least one of the hierarchy list, the highest priority control parameter, a current power consumption of the variable speed pump, time of day, feeding cycle of the aquatic life, and resting cycles of the aquatic life. The method further includes executing the highest priority action.

Other embodiments provide a recirculating aquaculture system for aquatic life. The system includes a culture tank, a plurality of sensors configured to control parameters in the system, a variable speed pump configured to circulate water through the culture tank, and a controller in communication with the plurality of sensors and the variable speed pump. The controller is configured to prioritize the plurality of control parameters based on a hierarchy list, select a highest priority control parameter, determine potential actions for each of the plurality of control parameters, and select a highest priority action based on at least one of the hierarchy list, the highest priority control parameter, a current power consumption of the variable speed pump, time of day, feeding cycle of the aquatic life, and resting cycles of the aquatic life. The controller is also configured to execute the highest priority action.

Further embodiments provide a method of regulating energy consumption in an aquaculture system including a culture tank that houses aquatic life. The method includes arranging a plurality of control parameters into a prioritized list based on a hierarchy list, determining a potential action based on a control parameter priority from the prioritized list, and executing the potential action.

These and other aspects of the invention will become apparent in light of the following detailed description.

### DESCRIPTION OF THE DRAWINGS

FIG. 1 is a schematic view of an aquaculture system according to one embodiment;

FIG. 2 is an isometric view of a culture tank for use in the system of FIG. 1;

FIG. 3 is an isometric view of a variable speed pump for use in the system of FIG. 1;

FIG. 4 is an exploded isometric view of the variable speed pump of FIG. 3;

FIG. 5 is a front elevational view of a controller for use with the variable speed pump of FIG. 3;

FIG. 6 is an isometric view of an external controller for use with the system of FIG. 1;

FIG. 7 is a front isometric view of an oxygen cone for use with the system of FIG. 1;

FIG. 8 is a schematic representation of a gas diffusing column or gas diffuser for use with the system of FIG. 1; and

FIG. 9 is a flow chart illustrating a method for regulating energy consumption in the recirculating aquaculture system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein may be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Embodiments of the present disclosure provide systems and methods for operating a pump in an aquaculture recirculation system. Aquaculture recirculation systems include components and methods to support aquatic life including one or more of a culture tank, a water pump, a method of removing solid waste, a method of nitrification, and a method of gas exchange. In the present disclosure, the aquaculture system includes systems and methods for providing an efficient method of gas exchange. Aquatic life consume oxygen and produce carbon dioxide in molar equivalents during respiration. Specifically, the system disclosed herein is directed to monitoring the water quality for proper gas exchange, regulating energy consumption and use in the system, and maintaining a sustainable and healthy aquatic environment for the aquatic life.

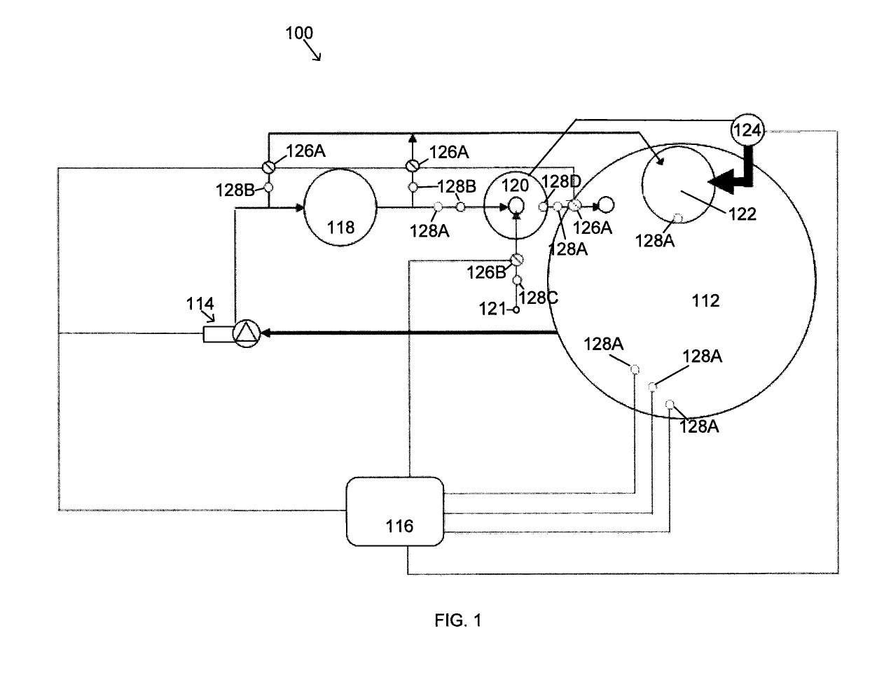

FIG. 1 illustrates an aquaculture system 100 according to one embodiment. The aquaculture system 100 may include one or more culture tanks 112 capable of housing aquatic life, a variable speed pump 114, a controller 116, a biofilter 118, an oxygen cone 120, an oxygen gas inlet 121, a degasser 122, an air blower 124, a plurality of control valves 126, and a plurality of sensors 128.

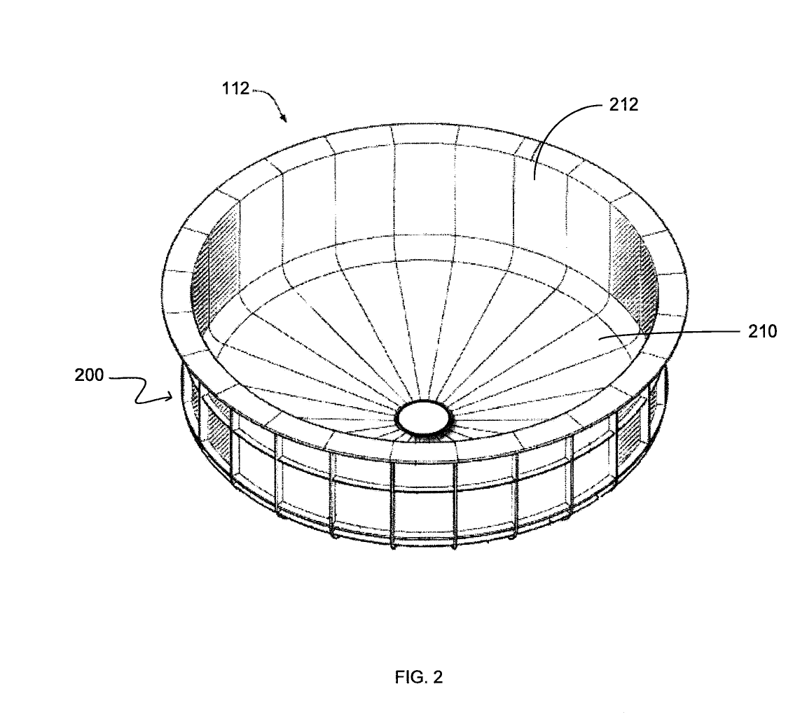

As depicted in FIG. 2, the culture tank 112 is designed to support and hold aquatic life and is provided in the form of a substantially cylindrical container 200 defined by a bottom surface 210 and a cylindrical sidewall 212 extending upwardly from the bottom surface 210. Although a specific culture tank 112 is depicted in FIG. 2, other culture tanks 112 may be used consistent with the functions described herein. Additionally, one or more culture tanks 112 may be provided in parallel and/or in series, or otherwise be in communication with each other to form the aquaculture system 100.

One or more portions of the culture tank 112 may be made of suitable materials that are inert and not reactive with water. For example, one or more portions of the culture tank 112 may be constructed of metal, vinyl, polymer, glass, fiberglass, steel, concrete, ceramic, wood, or of any combination thereof. One or more portions of the culture tank 112 may be constructed of clear materials, translucent materials, opaque materials, and/or of any combination thereof. The culture tank 112 may be configured to be circular, octagonal, rectangular, polygonal, irregular, D-shaped, crescent-shaped, or any combination thereof. In some embodiments, the culture tank 112 may include a cover (not shown) that includes portions that are clear, light filtering, light blocking, translucent, and/or combinations thereof.

The culture tank 112 is in fluid communication with the variable speed pump 114. The variable speed pump 114 provides circulation of water within the culture tank 112 by moving slower water from the bottom of the tank where carbon dioxide is rich. The variable speed pump 114 may have any suitable construction and/or configuration for providing the desired force to move the water. In one embodiment, the variable speed pump 114 is a common centrifugal pump of the type known to have impellers extending radially from a central axis. Vanes defined by the impellers create interior passages through which the water passes as the impellers are rotated. Rotating the impellers about the central axis imparts a centrifugal force on water therein, and thus imparts the force flow to the water. A return line directs the return flow of water to the culture tank 112. Although centrifugal pumps are well suited to pump a large volume of water at a continuous rate, other motor-operated pumps may also be used within the scope of the present invention.

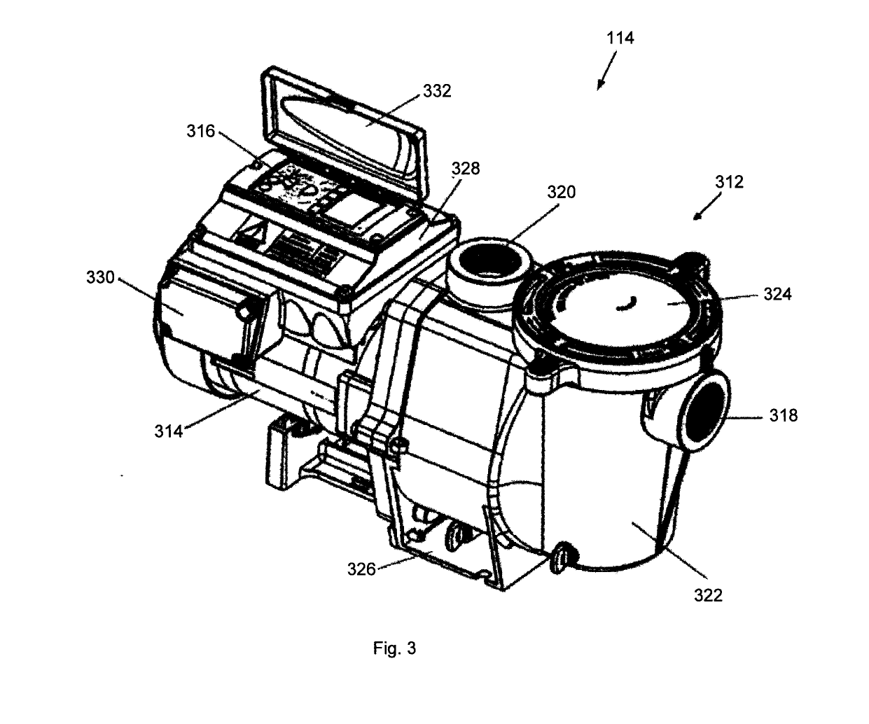

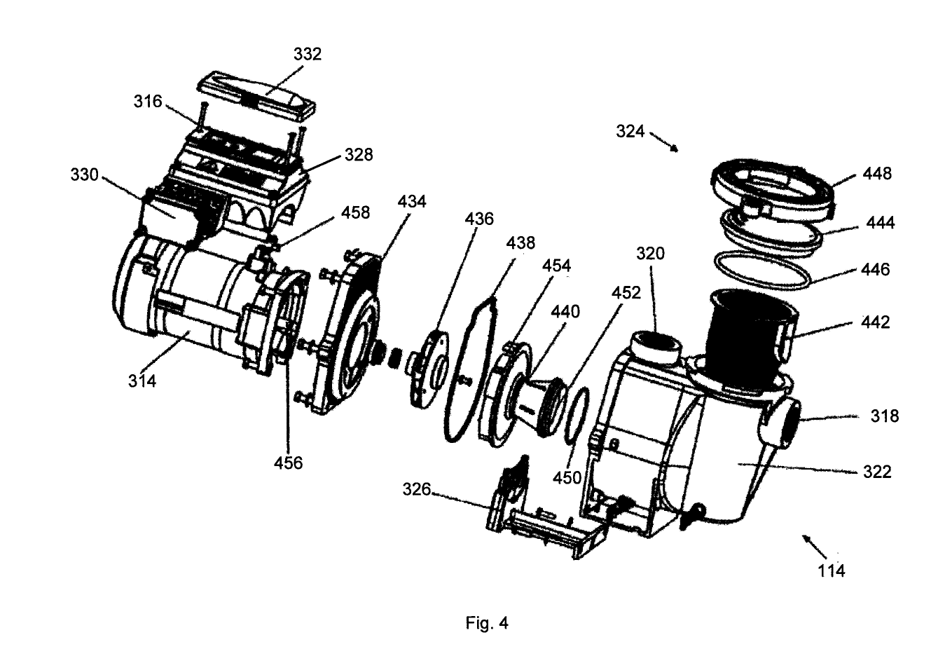

FIGS. 3 and 4 illustrate an embodiment of the variable speed pump 114 for use with the aquaculture system 100. The variable speed pump 114 may include a housing 312, a motor 314, and a controller 316 (which may include a variable frequency drive controller). The housing 312 may further include an inlet 318 for receiving water, an outlet 320 for expelling water, a basket 322, a lid 324, and a stand 326.

FIG. 4 depicts the internal components of the variable speed pump 114 according to one embodiment. The variable speed pump 114 may include a seal plate 434, an impeller 436, a gasket 438, a diffuser 440, and a strainer 442. The strainer 442 may be inserted into the basket 322 and may be secured by the lid 324. In some embodiments, the lid 324 may include one or more of a cap 444, an O-ring 446, and a nut 448. The cap 444 and the O-ring 446 may be coupled to the basket 322 by screwing the nut 448 onto the basket 322. The O-ring 446 may seal the connection between the basket 322 and the lid 324. An inlet 452 of the diffuser 440 may be fluidly sealed to the basket 322 with a seal 450. In some embodiments, the diffuser 440 may enclose the impeller 436. An outlet 454 of the diffuser 440 may be fluidly sealed to the seal plate 434 and the seal plate 434 may be sealed to the housing 312 with the gasket 438. The motor 314 may include a shaft 456, which may be coupled to the impeller 436. The motor 314 may rotate the impeller 436, drawing fluid from the inlet 318 through the strainer 442 and the diffuser 440 to the outlet 320.

Still referring to FIG. 4, drive force is provided to the variable speed pump 114 via the variable speed pump motor 314. In one example, the drive force is provided in the form of rotational force provided to rotate the impeller 436 of the variable speed pump 114. In one specific embodiment, the variable speed pump motor 314 is a permanent magnet motor. In another specific embodiment, the variable speed pump motor 314 is a three-phase motor. The variable speed pump motor 314 operation is infinitely variable within a range of operation (i.e., zero to maximum operation). In one specific example, the operation is indicated by the RPM of the rotational force provided to rotate the impeller 436 of the variable speed pump 114. In one embodiment, the motor 314 may be driven at four or more different speeds. In another embodiment, the motor may range from about ½ hp to about 11 hp, or more than about 11 hp. The stand 326 may support the motor 314 and may be used to mount the variable speed pump 114 on a suitable surface (not shown).

As shown in FIG. 4, the motor 314 may include a coupling 458 used to connect to a controller 316. The controller 316 may be associated with the variable speed pump 114, or may be provided separately (e.g., the controller 116). Each of the controllers discussed herein may be designed to control one or more operations and/or parameters of the aquaculture system 100, alone, or in conjunction with each other. In some embodiments, the controller 316 may automatically operate the variable speed pump 114 according to at least one schedule (e.g., an on-peak schedule, an off-peak schedule, a feeding schedule, an aquatic life rest schedule, etc.). In additional embodiments, the controller 316 may allow a manual operation of the variable speed pump 114. In other embodiments, the controller 316 may monitor the operation of the variable speed pump 114 and may indicate abnormal conditions of the variable speed pump 114 (i.e., through audible or visual alarms). In some embodiments, the controller 316 is configured within aquaculture system 100 to operate simultaneously or in conjunction with another controller 116. In other embodiments, the controller 316 is configured within the aquaculture system 100 to operate independently. In yet other embodiments, at least one of the controller 316 may be configured as an operating component of the aquaculture system 100.

The controller 316 may be enclosed in a case 328 (see FIGS. 3 and 4). The case 328 may include a field wiring compartment 330 and a cover 332. The cover 332 may be opened and closed to allow access to the controller 316 and protect the controller 316 from moisture, dust, and other environmental influences. The case 328 may be mounted on the motor 314 and/or another portion of the pump 104. In some embodiments, the field wiring compartment 330 may include a power supply (not shown) to provide power to the motor 314 and the controller 316.

Generally, the controllers 116 and/or 316 may adjust the speed of the variable speed pump 114 to maintain a desired flow rate of liquid through the system. More specifically, the variable speed pump 114 may be operated by the controllers 116 and/or 316 according to a flow control algorithm, as disclosed in U.S. Pat. No. 7,845,913 entitled “Flow Control” and issued Dec. 7, 2010, the entire contents of which is herein incorporated by reference. In addition, in some embodiments, the controllers 116 and/or 316 may be in two-way communication with the biofilter 118, one or more of the sensors 128, and/or one or more of the control valves 126. Two-way communication in the aquaculture system 100 may be performed as disclosed in U.S. Pat. No. 7,854,597 entitled “Pumping System with Two-Way Communication” and issued on Dec. 21, 2010, the entire contents of which is herein incorporated by reference in its entirety.

The controllers 116 and/or 316 may comprise a processor and memory interconnected with the processor via a communication link. An optional RFID module may be interconnected with the processor via a second communication link, and/or an optional “WI-FI” module interconnected with the processor via a third communication link. In some embodiments, microcode, instructions, databases, and/or combinations thereof are encoded in the memory. In certain embodiments, the memory comprises non-volatile memory. In certain embodiments, the memory comprises battery backed up RAM, a magnetic hard disk assembly, an optical disk assembly, an electronic memory, or combinations thereof. The term “electronic memory” can include one or more of a PROM, EPROM, EEPROM, SMARTMEDIA, FLASHMEDIA, and other suitable types of chips and memory devices.

The processor may use the microcode to operate the controllers 116 and/or 316 (independently or in tandem). The processor may use microcode, instructions, databases, and combinations thereof to operate one or more of the variable speed pump 114, the biofilter 118, the oxygen cone 120, the oxygen gas inlet 121, the degasser 122, the air blower 124, the plurality of control valves 126, the plurality of sensors 128, or combinations thereof.

The controllers 116 and/or 316 may monitor one or more parameters of the system and may automatically execute necessary actions (e.g., adjusting water flow rates, air flow rates, the control valves 126, etc.) to ensure optimal aquatic life conditions within the culture tank 112. Furthermore, the controllers 116 and/or 316 may execute one or more actions to reduce energy consumption of the system. More specifically, substantial costs of maintaining aquaculture systems generally include feed costs, electricity costs, oxygen costs, and combinations thereof. The controllers 116 and/or 316, either as a separate component from the variable speed pump 114 (i.e., the controller 116), or integrated into the variable speed pump 114 (i.e., the controller 316), may control components of the system (e.g., the variable speed pump 114, the air blower 124, the control valves 126, combinations thereof, etc.) to maintain optimal aquatic life conditions in addition to minimizing electricity and oxygen costs.

For example, the controllers 116 and/or 316 may control the variable speed pump 114 to operate at a low speed to maintain a minimum water flow rate necessary to achieve optimal aquatic life conditions and may also increase the speed and, thus, water flow rate only when necessary (such as to increase dissolved oxygen levels during feeding). In contrast to conventional systems with single speed pumps that constantly run at a high speed, the variable speed pump 114 and the controllers 116 and/or 316 of the aquaculture system 100 may greatly minimize electricity and power consumption of the system. Furthermore, automatic execution of necessary actions to variably adjust water and oxygen/air flow may minimize electricity and power consumption in comparison to conventional systems. Moreover, the aquaculture system 100, including automatic control by the controllers 116 and/or 316, allows for rapid and efficient maintenance following startup since the typical learning curve of manual system operators is removed.

According to one embodiment, the controllers 116 and/or 316 may provide automatic carbon dioxide control for the system. Generally, when the carbon dioxide concentration in the water is too high, the system requires degassing. Degassing may be accomplished by increasing water flow rate via the variable speed pump 114, air flow rate through the degasser 122 via the air blower 124, or any combination of these actions. The controllers 116 and/or 316 may determine which of these actions to execute based on a gas to liquid ratio (G:L) within the degasser 122. The controllers 116 and/or 316 may calculate the G:L using the current water flow rate and the current air flow rate within the degasser 122. In one embodiment, the current water flow rate and the current air flow rate may be determined from the sensors 128 within the system. In another embodiment, the current water flow rate and the current air flow rate may be determined in a sensor-less manner by measuring one or more characteristics of the variable speed pump 114.

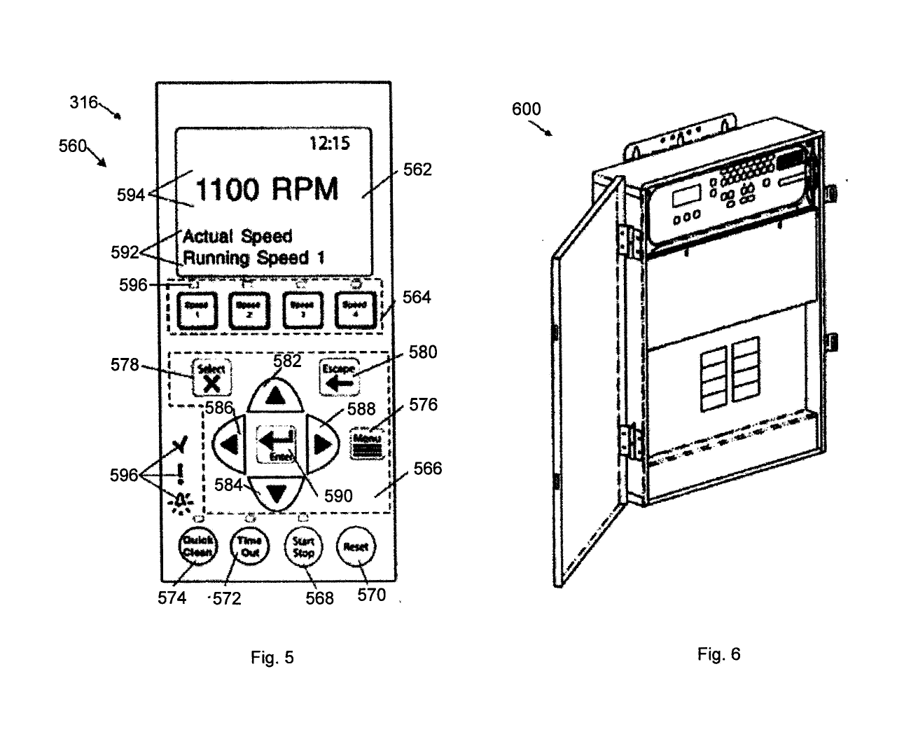

FIG. 5 illustrates a user interface 560 for the controller 316 according to one embodiment of the invention. The user interface 560 is provided to allow a user to control one or more components, parameters, and/or methods associated with the aquaculture system 100. The user interface 560 may include a display 562, at least one speed button 564, one or more navigation buttons 566, a start-stop button 568, a reset button 570, a manual override button 572, and a “quick clean” button 574. The manual override button 572 may also be called a “time out” button. In some embodiments, the navigation buttons 566 may include a menu button 576, a select button 578, an escape button 580, an up-arrow button 582, a down-arrow button 584, a left-arrow button 586, a right-arrow button 588, and an enter button 590. The navigation buttons 566 and the speed buttons 564 may be used to program a schedule into the controller 316. In some embodiments, the display 562 may include a lower section 592 to display information about a parameter and an upper section 594 to display a value associated with that parameter. In some embodiments, the user interface 560 may include one or more light emitting diodes (LEDs) 596 to indicate normal operation and/or a detected error of the variable speed pump 114, and/or other operational components of the aquaculture system 100.

FIG. 6 illustrates an external controller 600 for the variable speed pump 114. The external controller 600 may communicate with the controllers 116 and 316. The external controller 600 may control the variable speed pump 114, and/or other components of the aquaculture system 100, in substantially the same way as described for the controllers 116 and 316. The external controller 600 may be used to operate the variable speed pump 114 and/or program the controllers 116 and 316, if the variable speed pump 114 is installed in a location where the user interface 560 is not conveniently accessible. The external controller 600 may include one or more of the buttons described herein and may be used to control one or more components, parameters, and/or methods associated with the aquaculture system 100, either as a standalone controller, or in conjunction with the on-board controller 316.

Returning again to the aquaculture system 100 shown in FIG. 1, the variable speed pump 114 is in fluid communication with the biofilter 118. Biological filtration and nitrification may be accomplished by the biofilter 118 (e.g., a fluidized bed filter, a mixed bend filter, a trickling filter, a rotating biocontactor, a membrane bioreactor, etc.). The biofilter 118 provides ammonia removal by a biological filter (nitrification) which consists of the successive oxidation of ammonia to nitrite (NO₂⁻) and finally to nitrate (NO₃⁻). The process is usually actuated by autotrophic bacteria via an aerobic biofilter process. The biofilter 118 may be a submerged biofilter, trickling biofilter, rotating biological contactor, floating bead biofilter, dynamic bead biofilter, fluidized-bed biofilter, and/or other type biofilter that is designed to complete nitrification and is associated with water quality, and combinations thereof. In some embodiments, the biofilter 118 may operate under a low-head moving bed biological reactor concept using bioreactor media to provide efficient biological filtration.

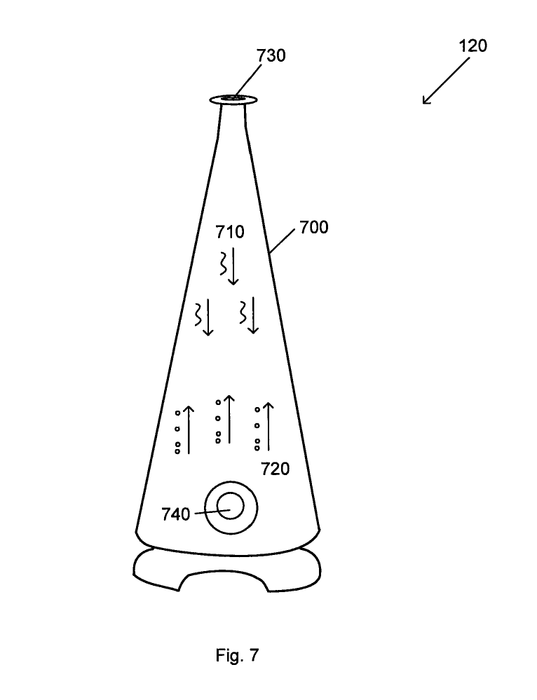

The biofilter 118 is in fluid communication with the oxygen cone 120 (shown in more detail in FIG. 7). The availability of dissolved oxygen (DO) is one factor that limits increased carrying capacity and production in aquaculture recirculation systems. Using only aeration as a means of providing dissolved oxygen, a typical aquaculture system can support only about 40 kg/m³ of water. However, by using pure oxygen (e.g., supplied by the oxygen gas inlet 121) and high efficient gas transfer devices (e.g., the oxygen cone 120) to increase the amount of dissolved oxygen in the water column, stocking densities of the aquatic population can be increased to over about 120 kg/m³ of water. For example, by increasing the DO concentration at gas inlet 121 to the culture tank 112 from about 10 mg/L (aeration alone) to about 18 mg/L using pure oxygen, and assuming a DO concentration of about 6 mg/L at the discharge, the carrying capacity of the system can be increased by a factor of at least about three. Thus, instead of a concentration of DO of about 4 mg/L (10 mg/L minus 6 mg/L) being available for respiration and metabolism by the fish, DO in a concentration of about 12 mg/L becomes available (18 mg/L minus 6 mg/L). Moreover, use of suitable oxygen saturators may result in an increase in stocking densities from about 40 kg/m³ to about 120 kg/m³.

The aquaculture system 100 includes the oxygen cone 120 and/or oxygen saturators that may efficiently optimize gas transfer (e.g., of oxygen or ozone) in the water of the culture tank(s) 112. More specifically, the oxygen cone 120 uses the change in water velocity that occurs in different diameter pipes to ensure complete or substantially complete diffusion of pure oxygen bubbles. As shown in FIG. 7, water and oxygen flow downward (represented by 710) through the oxygen cone 120 decreasing water velocity as the diameter of the body of the oxygen cone 120 widens. Simultaneously, oxygen bubbles (represented by 720) from the downward oxygen flow (or that are injected into the bottom of the oxygen cone 120) rise upwardly against the counter flowing water 710 until the velocity of the downward flowing water 710 equals the speed of the oxygen bubbles rising 720, which allows the oxygen gas to slowly diffuse into the water. The oxygen cone 120 automatically generates a range of velocities of water and gas flow, which even with small fluctuations in water and gas flow, allows the oxygen gas to diffuse into the water.

The oxygen cone 120 further functions to increase gas pressure in order to overcome surface water tension and enable the oxygen to diffuse more easily into the water. The oxygen cone 120 comprises a cone shaped cylinder 700 (see FIG. 7) or a series of pipes with reducing diameters (not shown), constructed of fiberglass or other suitable material. The oxygen cone 120 includes an inlet 730 to provide fluid water and gas flow into the oxygen cone 120 from the biofilter 118. The oxygen cone 120 further includes an outlet 740 to provide fluid communication with the air blower 124. Absorption efficiency of the oxygen cone 120 may range from about 95% to about 100% with effluent concentrations from about 30 mg/L to about 90 mg/L. In some systems, the oxygen cone 120 may transfer from about 0.2 kilograms of oxygen per hour to about 4.9 kilograms of oxygen per hour at about 25 mg/L, at oxygen flow rates from about 170 L/min to about 2,300 L/min.

The aquaculture system 100 further includes the regenerative air blower (e.g., the air blower 124) that is in fluid communication with the oxygen cone 120. Diffuser-based aeration increases gas exchange by providing increased surface area of the gas/water interface at the bubble surface. Diffuser-based aeration also stirs the water, which thins the stagnant boundary layer at the bubbles and the top of the water. A primary method of creating diffuser-based aeration is to move the air. The air blower 124 is designed to provide large volumes of air (e.g., from about 0.37 m³/min to about 36.1 m³/min) at low pressures (less than about 27.58 KPa) and is commonly used in conjunction with one or more of air diffusers and/or air lifts. The combination of the air blower 124 with one or more air diffusers adds oxygen and removes carbon dioxide with relatively low power consumption. The air blower 124 uses energy to move more air at lower pressure rather than less air at higher pressure. For example, the air blower 124 may include a motor having about 2.5 hp (not shown) that moves air at about 3.4 m³/min at about 103.4 KPa, or may operate in corrosive environments and deliver oil-free air, for example, to water in the biofilter 118. The air blower 124 may comprise an outer casing with a corrosion resistant metal fan and includes both input and output valves. The input and output valves of the air blower 124 may be provided with filtering baffles and materials that aid in the elimination of noise and vibration reduction.

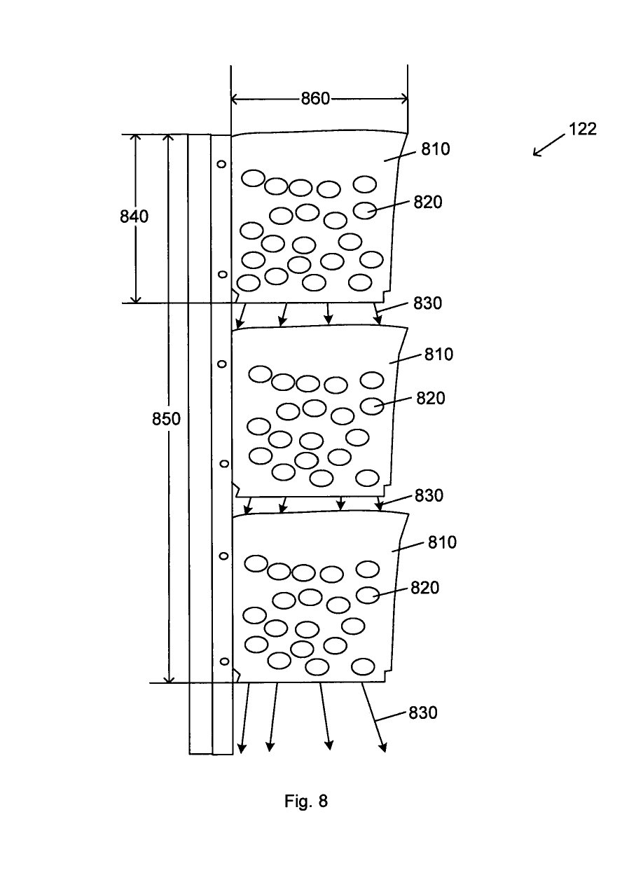

The air blower 124 is in fluid communication with a degassing column (e.g., the degasser 122). As shown in FIG. 8, the degasser 122 generally includes at least one of a plurality of subsegments 810 that is filled with a packing medium 820. The subsegment 810 may be manufactured of suitable materials that are inert and not reactive with water. For example, subsegment 810 may be manufactured of rubber, polymers, polyethylene, heavy duty polyethylene, heavy duty UV-resistant polyethylene, or the like, and/or combinations thereof. The subsegment 810 may be in fluid communication with at least one other of the plurality of subsegments 810. The packing medium 820 may have a large (above about 90 percent) void or empty space per unit volume and may be packed in a way that allows the water flow 830 to break up randomly into a thin film that trickles down through the degasser 122 and follows a circuitous pathway. A perforated support plate (not shown) supports the medium within the subsegment 810 at the bottom of the degasser 122. Near the top of the degasser 122, a water distribution plate (not shown) with a plurality of holes is placed over the packing medium 820.

The degasser 122 may have a height parameter 850 that may be based on a number of design criteria and may be dependent upon the characteristics of the incoming water. For example, the height parameter 850 may be selected for the degasser 122 to provide at least 90 percent saturation of water with dissolved oxygen. Similarly, a required segment diameter 860 of the degasser 122 depends on water flow rate. For example, water flow rates to the degasser 122 may range from about 0.15 m³/min to about 0.57 m³/min, with the segment diameter 860 generally up to about 30.5 cm or up to about 45.7 cm. For example, the degasser 122 may have a water flow rate of about 0.38 m³/min to about 0.57 m³/min and a segment diameter 860 of about 30.5 cm to about 45.7 cm. In one embodiment, each subsegment 810 of the degasser 122 may have a segment height 840 of about 45.7 cm, a segment diameter 860 of about 40.6 cm with a water flow loading capacity of about 0.57 m³/min, and may be substantially packed with about 0.017 m³ of suitable packing medium 820 such as plastic, polyethylene, black polyethylene, or the like, and/or combinations thereof. In additional embodiments, each subsegment 810 of the degasser 122 may have a segment height 840 of about 20 cm, about 30 cm, about 40 cm, about 50 cm, or about 60 cm; each subsegment 810 of the degasser 122 may have a segment diameter 860 of about 30 cm, about 40 cm, about 50 cm, about 60 cm, or about 70 cm with a water flow loading capacity of about 0.10 m³/min, about 0.20 m³/min, about 0.30 m³/min, about 0.40 m³/min, about 0.50 m³/min, about 0.60 m³/min, or about 0.70 m³/min and may be substantially packed with about 0.005 m³, about 0.010 m³, about 0.020 m³, or about 0.025 m³, of suitable packing medium 820.

The degasser 122 is used for removing nitrogen, hydrogen sulfide, carbon dioxide, other gases, and/or a combination thereof from water. The degasser 122 may also add oxygen to undersaturated water. In the recirculating aquaculture system 100, where oxygen is used, carbon dioxide levels may rise to narcotic or toxic levels. The packed segments 810 of the degasser 122 may serve two roles, depending upon the quality of incoming water. For example, if water is supersaturated with dissolved gases, the degasser 122 may substantially relieve the supersaturated condition. Additionally, for instances where the dissolved oxygen concentration of the water is low, the degasser 122 may substantially saturate the water with dissolved oxygen.

The aquaculture system 100 includes the plurality of valves 126, which are used to regulate the flow and/or pressure of water and/or gas within the culture tank 112. The plurality of valves 126 may include, but are not limited to, water proportional control valves 126A (see FIG. 1), oxygen gas proportional control valves 126B (see FIG. 1), and other control valves that are designed to regulate the flow and/or pressure of water and/or gas or air associated with water quality, and combinations thereof. For example, each of the plurality of valves 126 may include actuators and/or positioners to open and close the valves in order to regulate the flow and/or pressure therethrough.

The aquaculture system 100 also includes the plurality of sensors 128. The plurality of sensors 128 are used to detect levels of at least one of oxygen, nitrite, ammonia, carbon dioxide, other analytes, and the like, and combinations thereof, within the water of the culture tank 112. The plurality of sensors 128 may be positioned throughout the system and are in communication with the controllers 116 and/or 316 for monitoring one or more parameters of the system. Parameters of the system may include, but are not limited to, dissolved oxygen, nitrite, ammonia, carbon dioxide, water flow rate, oxygen gas flow rate, oxygen gas pressure, water pressure, suspended solids, undissolved oxygen, nitrate, temperature, pH, salinity, conductivity, oxidation-reduction potential (ORP), turbidity, atmospheric pressure, water level, saturation, alkalinity, and other water quality parameters known in the art. Some parameters, such as dissolved oxygen, carbon dioxide, ammonia, temperature, may be measured directly from the sensors 128 (e.g., digital probes or potentiometers). Other parameters, such as alkalinity, saturation, etc. may be measured or calculated indirectly by the controllers 116 and/or 316 (e.g., through equations and/or stored lookup tables) using outputs from the sensors 128 (e.g., optical sensors, ultrasonic sensors, infrared sensors, etc.). The plurality of sensors 128 may include, but are not limited to, water quality probes 128A, water flow rate sensors 128B, oxygen gas flow rate and pressure sensors 128C, water pressure sensors 128D, and other sensors that are designed to detect one or more analytes or parameters associated with water quality, and combinations thereof.

In some embodiments, the water quality probes 128A may include bare electrode cell and membrane cell analytical sensors. For example, for disinfectant measurement, the water quality probes 128A may include a three-electrode sensor that eliminates the need for zero-adjustment as in conventional sensors. Hydrodynamic grit cleaning of the electrode surfaces maintains sensitivity to extend the intervals between calibrations. In another embodiment, the water quality probes 128A may include an internally buffered membrane type sensor to eliminate the need for separate reagents for free and substantially total chlorine measurement, or when water exhibits fluctuating pH. In yet another embodiment, the water quality probes 128A may include a flow cell assembly comprising a corrosion-proof acrylic housing, a transparent flow chamber, a pressure gauge, a sample valve, a flow switch, isolations valves, and combinations thereof for pH and oxidation-reduction potential (ORP) measurements.

The water flow rate sensors 128B and the oxygen gas flow rate sensors 128C may comprise mechanical flow meters that use positive-displacement flow meters to accumulate a fixed volume of fluid or gas and then count the number of times the volume is filled to measure flow. The water flow rate sensors 128B and the oxygen gas flow rate sensors 128C may comprise pistons reciprocating in cylinders, gear teeth mating against the internal wall of the meter through a progressive cavity created by rotating oval gears, a helical screw, other suitable water/gas flow rate sensor, or combinations thereof. For example, the water flow rate sensors 128B and the oxygen gas flow rate sensors 128C may comprise mechanical flow meters such as piston meters, gear meters, oval gear meters, helical gear meters, nutating disk meters, variable area meters, turbine flow meters, Woltmann meters, single jet meters, paddle wheel meters, multiple jet meters, Pelton wheels, current meters, other suitable water/gas flow rate sensors, or combinations thereof.

In another embodiment, the water flow rate sensors 128B and the oxygen gas flow rate sensors 128C may comprise sensors that rely on forces produced by the flowing stream as the water or gas flow overcomes a known constriction to indirectly calculate flow rate. In yet another embodiment, the water flow rate sensors 128B and the oxygen gas flow rate sensors 128C may measure flow by measuring the velocity of fluid or gas over a known area. In other embodiments, the water flow rate sensors 128B and the oxygen gas flow rate sensors 128C may comprise pressure-based meters, optical flow meters, open channel flow meters, thermal mass flow meters, vortex flow meters, electromagnetic flow meters, ultrasonic flow meters, Coriolis flow meters, laser Doppler flow meters, other suitable water flow rate or gas flow rate sensors associated with water quality, or combinations thereof.

The oxygen gas pressure sensors 128C and the water pressure sensors 128D may comprise force collector sensors or other suitable type pressure sensors. Force collector type sensors use a force collector such as a diaphragm, piston, bourdon tube, bellows, or combinations thereof to measure strain (or deflection) due to applied pressure force over an area. The oxygen gas pressure sensors 128C and the water pressure sensors 128D may comprise piezoresistive strain gauges that use the piezoresistive effect of bonded or formed strain gauges to detect strain due to applied pressure. Piezoresistive strain gauges employ a few common types of technologies including silicon (monocrystalline), polysilicon thin film bonded metal foil, thick film, sputtered thin film, or the like, or combinations thereof. Generally, the strain gauges are connected to form a Wheatstone bridge circuit to maximize the output of the sensors and to reduce sensitivity to errors. Generally, these technologies are suited to measure absolute, gauge, vacuum, differential pressures, or combinations thereof. In other embodiments, the oxygen gas pressure sensors 128C and the water pressure sensors 128D may comprise capacitive sensors, electromagnetic sensors, piezoelectric sensors, optical sensors, potentiometric sensors, resonant sensors, thermal sensors, ionization sensors, other suitable water pressure or gas pressure sensors, or combinations thereof.

The component parts having been described, operation of the aquaculture system 100 will now be discussed. More particularly, water may be recirculated through the aquaculture system 100 using the variable speed pump 114, (i.e., through the fluid circuit) for treatment to ensure optimal aquatic life conditions within the culture tank 112.

Components of the aquaculture system 100 including the culture tank 112, the variable speed pump 114, the biofilter 118, the degasser 122, and the oxygen cone 120 may form a fluid circuit in which the treated water is circulated. In addition, one or more components of the aquaculture system 100 including the variable speed pump 114, the biofilter 118, the oxygen cone 120, the oxygen gas inlet 121, the degasser 122, the air blower 124, the plurality of control valves 126, the plurality of sensors 128, or any combination thereof may be in fluid communication with and/or automatically operated by one or more of the controllers 116, 316, 600.

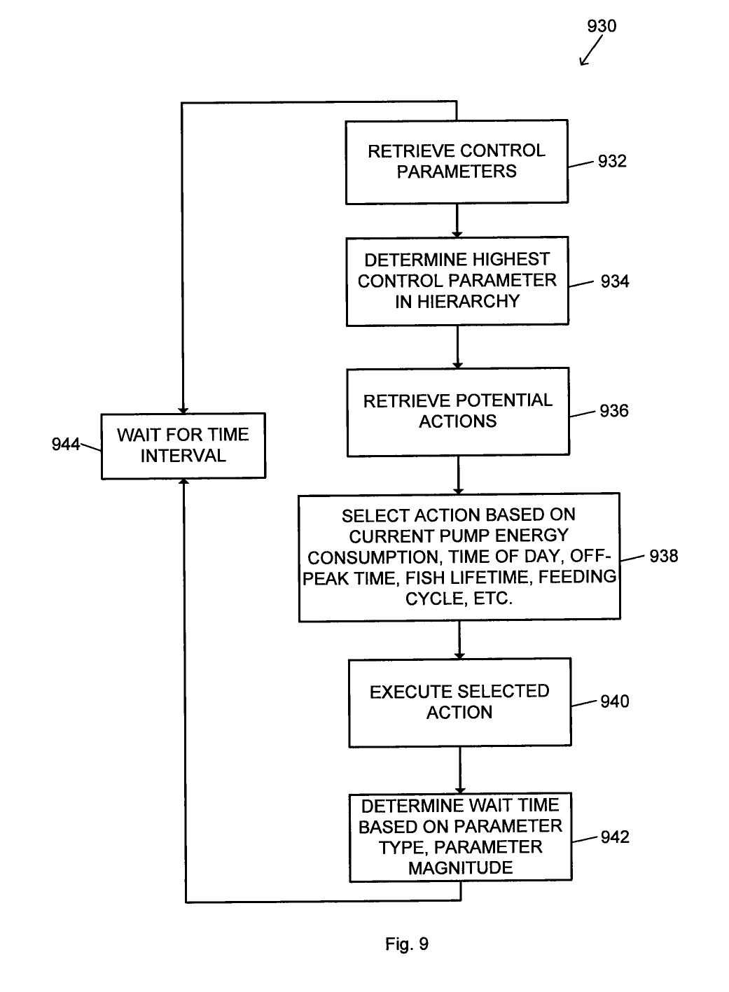

FIG. 9 illustrates a method 930 (e.g., as executed by the controller 116) for regulating energy consumption of the aquaculture system 100 according to one embodiment. Generally, the method 930 may include the step of selecting and executing actions with respect to the aquaculture system 100 in a hierarchical manner based on prioritized control parameters, control actions, other energy-dependent variables, or a combination thereof. More specifically, as shown in FIG. 9, the method 930 may include the step of retrieving control parameters (step 932). By the phrase “control parameters” it is meant to include at least control parameters, other energy-dependent variables, or a combination thereof. The control parameters, may include, but are not limited to the concentrations and/or levels of dissolved oxygen, nitrite, ammonia, carbon dioxide, undissolved oxygen, nitrate, pH, salinity, turbidity, saturation, alkalinity, suspended solids, or the like, or combinations thereof. Further, the control parameters, may also include, but are not limited to the temperature, conductivity, ORP, water level, water flow rates, water pressure, oxygen gas pressure, or the like, or combinations thereof. In some embodiments, the controller 116 may include the step of retrieving all of the control parameters for each process iteration of the method 930. In other embodiments, the controller 116 may include the step of retrieving only the control parameters having control action instructions (e.g., based on control processes individually executed for each specific parameter). Control action instructions may include the step of adjusting water flow rate (i.e., by adjusting a speed of the variable speed pump 114), adjusting water pressure (i.e., by adjusting one or more of the control valves 128), controlling the air blower 124 (e.g., to add more or less oxygen gas to the degasser 122), or the like, or combinations thereof.

The method 930 may include the controller 116 executing the step of determining, of the retrieved parameters in step 932, a highest priority control parameter based on one or more hierarchical lists stored in the controller 116 (at step 934). Step 934 may also include the action of arranging all retrieved control parameters into a prioritized control parameters list based on the one or more stored hierarchy lists of control parameters. In one example, the stored hierarchy list of control parameters may include, but is not limited to the following (in order of priority): the temperature, conductivity, ORP, water level, water flow rates, water pressure, oxygen gas pressure, or the like, or combinations thereof. In some embodiments, the controller 116 may use a particular stored hierarchy list based on a time of day such as an “off-peak hours” list including feeding times, rest times, or the like, or a combination thereof.

Following step 934, the method 930 may include the controller 116 executing the step of retrieving potential control actions (i.e., action instructions) associated with each of the retrieved control parameters (at step 936). In some embodiments, step 936 may include the action of initiating individual control processes associated with each control parameter to determine potential control actions. In one embodiment, the controller 116 may select a first control action to execute based on one or more of the hierarchy lists of potential control actions associated with each of the retrieved control parameters such as a current energy consumption of the variable speed pump 114, a current run schedule of the variable speed pump 114, a time of day (e.g., on-peak hours or off-peak hours), species, size and/or age (i.e., growth cycle) of aquatic life, feeding cycles, resting cycles, or the like, or combinations thereof (at step 938). For example, the controller 116 may select the control action of directly adding oxygen gas via the oxygen gas inlet 121 to the aquaculture system 100 during off-peak hours to reduce oxygen supply costs. As a result, during on-peak hours, the controller 116 may select an initial potential control action based on one or more of the hierarchy lists of potential control actions, such as increasing water flow rate by increasing a speed of the variable speed pump 114, increasing water pressure by controlling one or more of the valves 126, another suitable control action, or a combination thereof, over the potential control action of directly adding oxygen gas via the oxygen gas inlet 121 to the aquaculture system 100. It is envisioned that the effect of the selection of a control action associated with the retrieved control parameters based on one or more of the stored hierarchy lists may be to substantially minimize oxygen usage and/or waste within the aquaculture system 100 during on-peak hours and provide an increased economic efficiency of the aquaculture system 100. Upon the controller 116 selection at step 938 of the method 930, the controller 116 may execute the selected potential control action (step 940).

After execution of the selected control action at step 940, the controller 116 may determine a predetermined time period (step 942). The predetermined time period may be a suitable time period to allow the aquaculture system 100 to reach steady state conditions reflecting the control action or control process taken. For example, the predetermined time period may be based on a number of variables such as, but not limited to, a volume of the culture tank 112, a control action executed, a magnitude of control action executed (e.g., a longer predetermined time period for larger water flow increases vs. a shorter time period for smaller water flow increases), an energy regulation action executed (e.g., minimizing unnecessary process iterations and actions executed during on-peak hours), the feeding or rest times of the aquatic life (e.g., increasing the number of process iterations and actions executed by selecting a shorter predetermined time period during feeding times or decreasing the number of process iterations and actions executed by selecting a longer predetermined time period during rest times), or a combination thereof. In some embodiments, a lookup table of predetermined time periods may be stored by the controller 116, and the controller 116 may determine the appropriate predetermined time period based on one or more of the variables discussed above.

In some embodiments, the predetermined time period may be integrated into individual control processes associated with each control parameter and steps 932 through 942 may be executed as an interrupt routine when an individual control process initiates a specific control action instruction requiring a predetermined time period. As a result, step 944 may include reverting back to the individual control process to execute the predetermined time period as selected or set by the individual control process. In other embodiments, the predetermined time period may be independent from the predetermined time periods set by other control processes. In further embodiments, step 944 may include the step of waiting until another individual control process initiates a control action instruction. Following step 944, the controller 116 may revert back to step 932 and repeat the above process.

In some embodiments, the controller 116 may monitor and/or store the amount of energy consumed by the variable speed pump 114 over time (e.g., over a 24-hour time period). The amount of energy consumed may factor into the particular control action selected in step 938, as described above. Additionally, the controller 116 may initiate an alarm (e.g., an audible and/or visual alarm) to alert an operator of the aquaculture system 100 should the energy consumed exceed a maximum value of energy consumption (as stored in the controller 116).

Suitable water treatment of the water within the aquaculture system 100 may include one or more of carbon dioxide removal, disinfection, biological filtration, nitrification, waste solids removal, aeration, oxygenation, fine and dissolved solids removal, other suitable water quality treatments known in the art, and any combination thereof using the components described above and/or additional components.

Referring back to FIG. 1, the aquaculture system 100 may include additional components. For example, in some embodiments, rotating drum filters may be used for high-volume solids removal and a radial flow setter may be used to capture settable solids from the bottom drain of a dual drain system for solids removal. In some embodiments, the aquaculture system 100 of FIG. 1 may optionally include an ultraviolet (UV) sterilizer, an ozone generator, or any combination thereof. Disinfection may be accomplished by the ultraviolet (UV) sterilizer, the ozone generator, or a combination thereof. In other embodiments, the aquaculture system 100 of FIG. 1 may further include swirl separators, screen filters, bead filters, rotating drum filters, a double drain mechanism, or any combination thereof. Waste solids removal may be accomplished through sedimentation, using the swirl separators, the screen filters, the bead filters, the rotating drum filters, the double drain mechanism, or any combination thereof. In some embodiments, the aquaculture system 100 of FIG. 1 may further include a protein skimmer, also referred to as a foam fractionator, which may be used to remove dissolved solids, including any fine particulates that mechanical filtration does not catch. These dissolved solids are usually proteins that have broken down from wastes, uneaten food, and dead fish.

Although the controller 116 is described throughout, the controllers 316 and/or 600 may perform one or more of the functions associated with the controller 116.

Although numerous embodiments have been provided with respect to various components of the system 100, it should be apparent that one or more components may be omitted and/or additional components may be added to the system 100. Additionally, other types of the culture tank 112, the variable speed pump 114, the controller 116, the biofilter 118, the oxygen cone 120, the oxygen gas inlet 121, the degasser 122, the air blower 124, the plurality of control valves 126, and the plurality of sensors 128 may be used as known in the art, consistent with the disclosure as set forth herein.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of operating a pump in an aquaculture system, the aquaculture system including a culture tank that houses aquatic life, the method comprising:
retrieving a plurality of control parameters;
prioritizing the plurality of control parameters based on a hierarchy list;
selecting a highest priority control parameter;
determining potential actions for each of the plurality of control parameters;
selecting a highest priority action based on the hierarchy list; and
executing the highest priority action.

2. The method of claim 1, wherein the potential actions include at least one of adjusting a speed of the variable speed pump, controlling an air blower, and adjusting a control valve.

3. The method of claim 1, wherein selecting a highest priority action comprises selecting a highest priority action based on at least one of the highest priority control parameter, a current power consumption of the variable speed pump, time of day, feeding cycle of the aquatic life, and resting cycles of the aquatic life.

4. The method of claim 1 further comprising determining a predetermined time period following execution of the highest priority action before repeating the method steps.

5. The method of claim 4, wherein the predetermined time period is based on a volume of a culture tank.

6. A recirculating aquaculture system for aquatic life, the system including a culture tank, the system comprising:
a plurality of sensors configured to control a plurality of parameters in the system;
a variable speed pump configured to circulate water through the culture tank; and
a controller in communication with the plurality of sensors and the variable speed pump, the controller configured to:
prioritize the plurality of control parameters based on a hierarchy list;
select a highest priority control parameter;
determine potential actions for each of the plurality of control parameters;
select a highest priority action based on the highest priority control parameter; and
execute the highest priority action.

7. The recirculating aquaculture system of claim 6, wherein the controller includes a variable frequency drive.

8. The recirculating aquaculture system of claim 6, wherein the potential actions include at least one of adjusting a speed of the variable speed pump, controlling an air blower, and adjusting a control valve.

9. The recirculating aquaculture system of claim 6, wherein the controller is integrated into the variable speed pump.

10. The recirculating aquaculture system of claim 6, wherein the controller is configured to wait a predetermined time period after the highest priority action has been executed.

11. The recirculating aquaculture system of claim 10, wherein the predetermined time period is based on a volume of the culture tank.

12. The recirculating aquaculture system of claim 10, wherein the predetermined time period is based on the highest priority action executed.

13. The recirculating aquaculture system of claim 6, wherein the controller includes a user interface and the controller is configured to select a highest priority action based on user input.

14. The recirculating aquaculture system of claim 6, wherein the highest priority action is based on at least one of the hierarchy list, a current power consumption of the variable speed pump, a time of day, a feeding cycle of the aquatic life, and a resting cycle of the aquatic life.

15. The recirculating aquaculture system of claim 6, wherein the controller is further configured to initiate an alarm when an amount of energy consumed by the pump exceeds a threshold amount.

16. The recirculating aquaculture system of claim 6, wherein the controller is further configured to monitor or store an amount of energy consumed by the variable speed pump.

17. A method of regulating energy consumption in an aquaculture system, the aquaculture system including a culture tank that houses aquatic life, the method comprising:
arranging a plurality of control parameters into a prioritized list based on a hierarchy list;
determining a potential action based on a control parameter priority from the prioritized list; and
executing the potential action.

18. The method of claim 17, wherein the hierarchy list is based on at least one of a time of a day, a feeding time, and a rest time.

19. The method of claim 17, wherein determining a potential action further comprises basing the potential action on at least one of a current energy consumption of a variable speed pump, a time of day, a species, a size, an age of aquatic life, a feeding cycle, and a resting cycle.

20. The method of claim 17, further comprising waiting a predetermined time before repeating the arranging, the determining, and the executing steps.
